(19) United States
(12) Patent Application Publication
(10) Pub. No.: US 2019/0271586 A1
(43) Pub. Date: Sep. 5, 2019

(54) METHOD, APPARATUS AND COMPUTER PROGRAM FOR MEASURING AND PROCESSING A SPECTRUM OF AN XUV LIGHT SOURCE FROM SOFT X-RAYS TO INFRARED WAVELENGTH

(71) Applicant: Universiteit Twente, Enschede (NL)

(72) Inventors: Muharrem Bayraktar, Enschede (NL); Frederik Bijkerk, Bosch en Duin (NL); Hubertus Maria Jacobus Bastiaens, Enschede (NL); Casper Bruineman, Putten (NL)

(21) Appl. No.: 16/347,683

(22) PCT Filed: Nov. 3, 2017
(86) PCT No.: PCT/NL2017/050713

§ 371 Date: May 6, 2019

(30) Foreign Application Priority Data
Nov. 7, 2016 (NL) 2017729

(51) Int. Cl. G01J 1/42; G01J 3/28; G01J 3/18

(52) U.S. Cl. CPC G01J 1/429; G01J 2003/1204; G01J 3/18; G01J 3/2823

(57) ABSTRACT

Method for measuring and processing by means of a broadband spectrometer (1) a spectrum of light (7) generated by an XUV source for generating light in a wavelength range from soft x-rays to infrared wavelengths, wherein the processing is based on the assessment of a wavelength range in the measured spectrum which has a negligible higher order contribution to longer-wavelengths than said range.

The invention relates to a method for measuring and processing by means of a broadband spectrometer a spectrum of light in a wavelength range from soft X-rays to infrared wavelengths.

A broadband spectrometer is in general a spectrometer for measuring the spectrum of the light emitted by an XUV source, adapted to the wavelength range of the specific source. The wavelength range of XUV sources covers among others the soft X-ray range of wavelengths from about 0.1 nm to 5 nm, the extreme ultraviolet (EUV) range of wavelengths from about 5 nm to 40 nm, the vacuum ultraviolet (VUV) range of wavelengths from about 30 nm to 120 nm, and the ultraviolet (UV) range of wavelengths from about 120 nm to 400 nm. In literature, the nomenclature of these ranges is not sharply defined, and different names may be used for partly overlapping ranges.

XUV light sources are currently of much interest for a number of scientific and high-tech applications such as free-electron laser research, astronomy, elemental fluorescence analysis and photolithography.

Soft X-ray sources are used for instance for materials analysis using materials-specific absorption and fluorescence for the determination of the composition of samples having unknown materials compositions. In such an analysis, light of the source is impinging on the sample to be analysed, partially reflected from it, and spectrally recorded by the spectrometer.

In particular, EUV photolithography tools need optimization of their light source to emit in a narrow band (2% of the central wavelength) around 13.5 nm wavelength, i.e. in-band spectrum, in order to maximize their wafer throughput. In this regard, spectral monitoring of EUV photolithography tools is a vital step towards optimum productivity of these tools. Currently, the light source of EUV photolithography is monitored using an EUV reflective mirror, which filters the source emission, and a photodiode. This measurement scheme can precisely measure the in-band EUV power, but not the emission power outside the targeted EUV band. The out-of-band radiation spans a very broad wavelength range extending from soft x-rays (<5 nm) to infrared wavelengths (>700 nm) and can have hazardous effects such as parasitic exposure of the photoresist and excessive heat load on the EUV mirrors. In order to assess the out-of-band radiation, an extremely broadband detection scheme is needed.

Diffraction gratings suffer from a limited spectral bandwidth, due to an inherent property. The gratings diffract the incoming radiation into a set of diffraction orders according to grating equation m λ=d(sin θᵢ+sin θₘ). Here, in is an integer representing the diffraction order, λ is the wavelength, d is the grating period, θᵢ is the incidence angle and θₘ is the diffraction angle for the wavelength m λ. One indication of the grating equation is that higher (i.e. second an higher) diffraction order of a short wavelength diffracts to the same angle with the first diffraction order of a longer wavelength. Explicitly, second diffraction order of λᵢ diffracts to the same angle with first diffraction order of wavelength 2λ₁. This overlap of the wavelengths prevents accurate assessment of the complete out-of-band spectrum.

Another problem with commercially available EUV spectrometers arises from the limited number of intensity counts of the CCD cameras used in the spectrometers. Typically, the intensity level of the in-band 13.5 nm peak is orders of magnitude larger than the intensity levels of the out-of-band spectrum. Hence in-band spectrum can easily saturate the camera and prevent recording of the very low intensities in the out-of-band range.

US 2009/0046273 A1 discloses systems and methods for monitoring and controlling the operation of EUV sources used in semiconductor fabrication. A method comprises providing a semiconductor fabrication apparatus having a light source that emits in-band and out-of-band radiation, taking a first out-of-band radiation measurement, taking a second out-of-band radiation measurement, and controlling the in-band radiation of the light source, at least in part, based upon a comparison of the first and second out-of-band measurements. An apparatus comprises a detector operable to detect out-of-band EUV radiation emitted by an EUV plasma source, a spectrometer coupled to the electromagnetic detector and operable to at least one out-of-band radiation parameter based upon the detected out-of-band EUV radiation, and a controller coupled to the spectrometer and operable to monitor and control the operation of the EUV plasma source based upon the out-of-band measurements.

According to US 2009/0046273 A1, for the deep UV spectrum use was made of a grazing-incidence-angle reflection-spectrometer, which leads to bulky designs, difficulties in alignment procedures and high sensitivity to the contamination of grating and detector. The method comprises, a.o., the steps of taking a first out-of-band radiation measurement and taking a second out-of-band radiation measurement. From the tables shown, these prior art method and apparatus are silent about the out-of-band range from about 30 nm to 160 nm, which may contain a relatively high contribution of radiation power that can have hazardous effects such as parasitic exposure of photo resist and excessive heat load on EUV mirrors.

It is an object of the invention to provide an apparatus for measuring and optimizing a spectrum of EUV light sources from soft X-rays to infrared wavelengths by means of a broadband spectrometer which is compact and is easy to align, and which is provided by means for mitigation of undesired contamination by higher diffraction orders.

This object is achieved, and other advantages are realized, with a method of the type specified in the preamble, in which according to the invention the processing comprises the step of (a) assessing in a measured spectrum a longest wavelength λ₀, such that the contribution of higher diffraction orders of the spectrum for wavelengths shorter than the longest wavelength λ₀ to the part of the spectrum for wavelengths longer than λ₀ is below a previously defined value. The previously defined value may e.g. be chosen as a percentage by which the higher diffraction orders for wavelengths shorter than the longest wavelength λ₀ contribute to the part of the spectrum for wavelengths longer than λ₀.

It has been found that processing the spectrum based on the assessment of said longest wavelength enables the reconstruction of a complete spectrum, without excluding any wavelength, e.g. the range 30-160 nm which is excluded according to the prior art method referred above.

In an embodiment of the method according to the invention, wherein the broadband spectrometer comprises a shutter, one of a pinhole and a slit, at least one transmission grating and a camera, the processing comprises further the steps of (b) removing for wavelengths A in the range given by λ₀<λ<2λ₀ a broadening in the intensity of the light as recorded by the camera, due to the pinhole or slit, and dividing the intensity in the resulting wavelength range by the efficiencies of the grating and the camera, thus obtaining a recovered spectrum in a first spectral range, (c) calculating contributions of all higher order diffractions in the range given by λ₀<λ<2λ₀ to the range given by 2λ₀<λ4λ₀ and subtracting these contributions from the intensity of the light as recorded by the camera (6), thus obtaining a recovered spectral range for wavelengths λ in the range given by 2λ₀<λ<4λ₀, and (d) repeating the calculation according to steps (b) and (c) for the next adjacent wavelength range, thus obtaining a next adjacent recovered spectral range for wavelengths λ in a next adjacent range, until the complete spectrum as recorded by the camera has been processed and the spectrum from the source has been recovered.

In an embodiment wherein the spectrometer further comprises at least one spectral filter, step (b) of the method further comprises dividing the intensity in the resulting wavelength range by the efficiency of the filter.

The method according to the invention takes into account the effects of four physical processes affecting the spectrum before recording on a computer. The first physical process is the attenuation of the spectrum due to spectral filter. The second process is the broadening of the spectral features due to the pinhole/slit. The third process is the diffraction of the spectrum into several diffraction orders due to the transmission grating. The fourth process is detection by the camera, e.g. a CCD camera. These four processes can be mathematically written as:

$${I}_{r} ( λ ) = S * {\sum }_{m = 1}^{n} \frac{1}{m} {I}_{i} ( \frac{λ}{m} ) {η}_{m} ( \frac{λ}{m} ) {η}_{f} ( \frac{λ}{m} ) {η}_{CCD} ( \frac{λ}{m} ) \qquad ( 1 )$$

where Iᵣ is the recorded intensity and S is the pinhole/slit function in spatial coordinates, which causes broadening of the spectral lines on the CCD. This broadening is represented by the convolution operation, *, in Eq. (1). The letter m represents the order of diffraction, n represents the highest diffraction order attainable with the grating. The factor 1/m represents the increased dispersion with increasing diffraction order. Iᵢ is the intensity incident to the spectrometer, ηₘ is the diffraction efficiency of the grating for the m^{th} order, η_{f} is the transmission efficiency of the filter and η_{CCD} is the quantum efficiency of the CCD.

The method according to the latter embodiment starts by the step (a) of finding the wavelength range that has a higher order contribution to longer wavelengths below a previously defined. Typically the intensity at short wavelengths close to the zero-order is low and the higher order contributions of these short wavelengths are even lower since the diffraction efficiency of the higher orders are smaller than the first order. If one denotes the longest wavelength that has a higher order contribution below a previously defined value as λ₀, one can conclude that the spectral range λ₀<λ2λ₀ has a negligible higher order contamination. In this spectral range the incident intensity can be calculated by considering only the first diffraction order in Eq. (1). For this situation, Eq. (1) can be converted to:

$${I}_{i} ( λ ) = \frac{{S}^{- 1} * {I}_{r} ( λ )}{{η}_{1} ( λ ) {η}_{f} ( λ ) {η}_{CCD} ( λ )} \qquad ( 2 )$$

According to the step (b), in Eq. (2), the recorded intensity is first convolved with the inverse of the pinhole/slit function, S⁻¹, and regularization techniques for noise suppression are applied to remove the effect of the pinhole/slit and then divided by the efficiencies of the grating, filter and CCD.

According to the step (c), all higher order contributions of the wavelength range λ₀<λ<2λ₀ are calculated and subtracted from the recorded intensity as:

$${I}_{ro} ( λ ) = {I}_{r} ( λ ) - S * {\sum }_{m = 2}^{n} \frac{1}{m} {I}_{i} ( \frac{λ}{m} ) {η}_{m} ( \frac{λ}{m} ) {η}_{f} ( \frac{λ}{m} ) {η}_{CCD} ( \frac{λ}{m} ) \qquad ( 3 )$$

This step recovers the recorded intensity in the range λ₀<λ<4λ₀ and from this recovered intensity, I_{rc}, the incident intensity can be calculated using Eq. (2).

According to the step (d), the recovered spectral range is extended by repeating steps (b) and (c) until the complete spectrum is recovered.

In an embodiment wherein the light is EUV light, the step of measuring the spectrum of the EUV light comprises the measuring of an out-of-band spectrum by using a spectral filter which has a low transmission characteristic for radiation with a wavelength of 13.5 nm and a high transmission characteristic for out-of-band wavelengths. The use of such a filter allows spectrum recordings with much longer exposure times without saturation of the camera. Increasing the exposure time results in increasing the signal-to-noise ratio (SNR), hence enabling recording of low intensities in the out-of-band spectrum. This way, the limited counts of a camera can be utilized more effectively.

In a practically advantageous embodiment, the spectral resolution of the spectrometer is maximized by locating the pinhole or slit and the grating within the spectrometer at a maximum distance from the camera. In a practical situation, the grating/pinhole couple and pinhole are preferably placed at the entrance of the spectrometer.

The method of the present invention can be implemented as a computer program product with a program code, the program code being operative for performing one of the methods when the computer program product runs on a computer. The program code may for instance be stored on a machine readable carrier.

An embodiment of the inventive method is, therefore, a computer program having a program code for performing one of the methods described herein, when the computer program runs on a computer.

The invention further relates to an apparatus for measuring and processing a spectrum of light in a wavelength range from soft x-rays to infrared wavelengths, comprising a broadband spectrometer, which spectrometer comprises a shutter, one of a pinhole and a slit, at least one transmission grating and a camera according to the above described method, which apparatus is provided with processing means for assessing in a measured spectrum a longest wavelength λ₀, such that the contribution of higher diffraction orders of the spectrum for wavelengths shorter than the longest wavelength λ₀ to the part of the spectrum for wavelengths longer than λ₀ is below a previously defined value.

Preferably, the spectrometer comprises at least one spectral filter.

In an embodiment of the apparatus according to the invention, the shutter is held in a carrier which is mounted on a motorized translation stage for movement in transverse direction with respect to the incoming beam.

In order to facilitate recording of low intensities in the out-of-band spectrum, the at least one spectral filter in an embodiment has a low transmission characteristic for light at an in-band wavelength and a high transmission characteristic for out-of-band wavelengths.

The spectrometer in such an embodiment is for instance an EUV spectrometer, and the in-band represents a bandwidth of 2% around a central wavelength of 13.5 nm.

Preferably, the spectral filter is one selectable out of a set, which set hold in a carrier.

The carrier holding the set of spectral filters is for instance mounted on motorized translation stages for movement in transverse directions with respect to the incoming beam.

In a yet another embodiment, the pinhole or slit is held in a carrier which is mounted on motorized translation stages for movement in transverse and longitudinal directions with respect to the incoming beam.

In an advantageous embodiment, the transmission grating is one selectable out of a set, which set is hold in a carrier.

The carrier holding the set of transmission gratings may be mounted on motorized translation stages for movement in transverse and longitudinal directions with respect to the incoming beam.

The set of transmission gratings may be provided by a microchip showing an array containing individual transmission gratings, wherein the array is e.g. a 3×7 matrix in which the individual transmission gratings have line densities of respectively 500, 780, 1000, 1500, 1850, 2000, 2500 lines per mm and starting from 3000 up to 10000 (multiple from it) with 1000 lines per mm increments.

In a preferred embodiment the pinhole or slit and the grating are arranged at a distal position with respect to the camera.

In order to reduce stray light, in an embodiment in which the camera comprises a CCD chip, the broadband spectrometer comprises a blackened plate having an aperture corresponding to the surface dimensions of the CCD chip, placed between the grating and the camera in perpendicular position with respect to the path of the light beam.

The apparatus according to the invention is especially suited for controlling an XUV light source, for instance an EUV source to be used in a device for EUV lithography.

Therefore, in a preferred embodiment, the control means in an apparatus according to the invention are adapted for controlling an XUV light source in order to optimize a spectrum of such light source.

In the latter embodiment, the source spectrum might be optimized for instance by tuning the source parameters such as drive laser power, pulse duration, temporal pulse shape, focus size, focus shape, beam positioning, polarization, time delay between pre-pulse and main-pulse, and gas pressure.

The invention will now be elucidated hereinbelow on the basis of exemplary embodiments, with reference to the drawings.

In the drawings

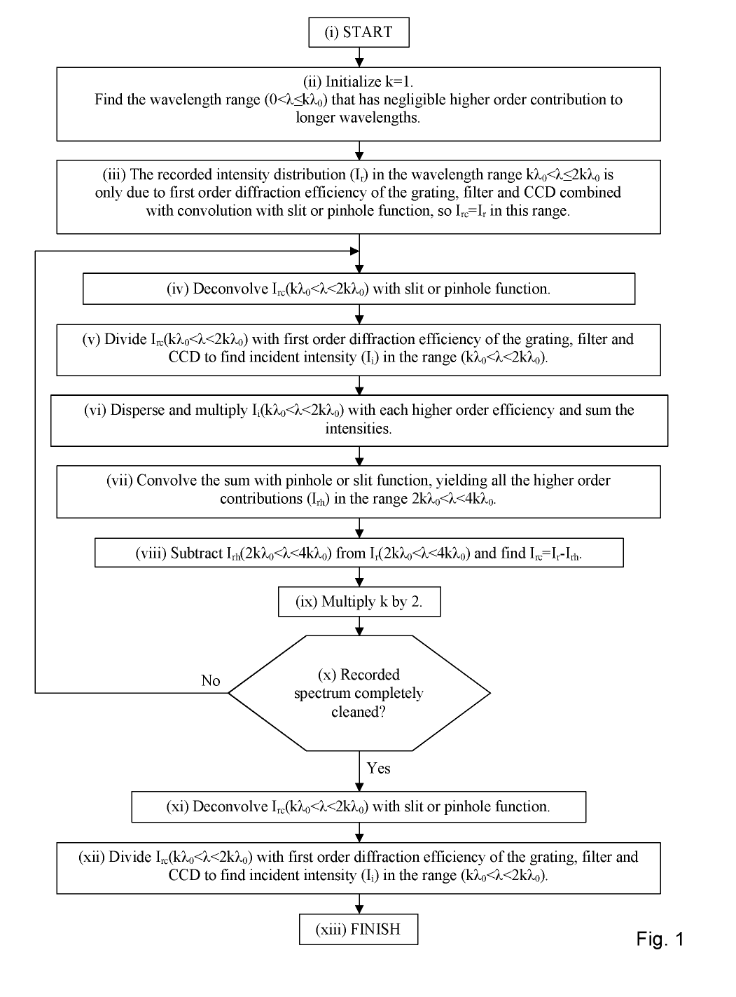

FIG. 1 shows a flow chart of an embodiment of the method according to the invention,

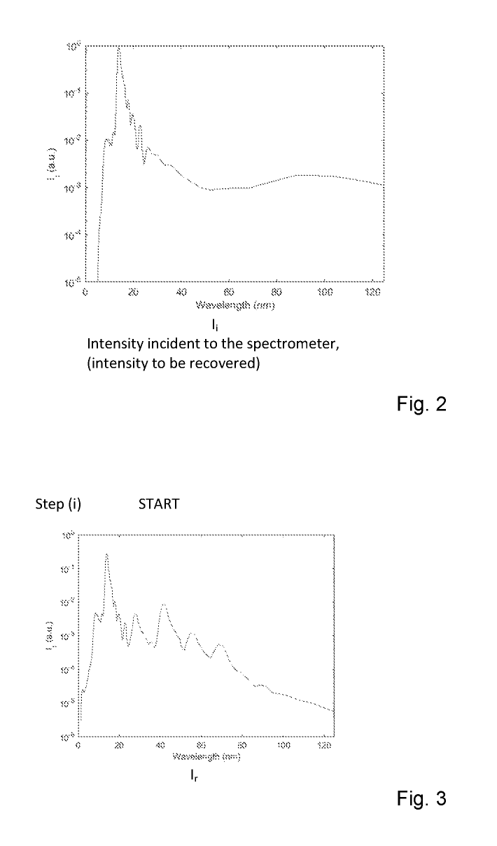

FIG. 2 shows a spectrum of a beam of EUV light as emitted by an EUV source, incident to an EUV spectrometer,

FIG. 3 shows the spectrum shown in FIG. 2 as recorded by the EUV spectrometer,

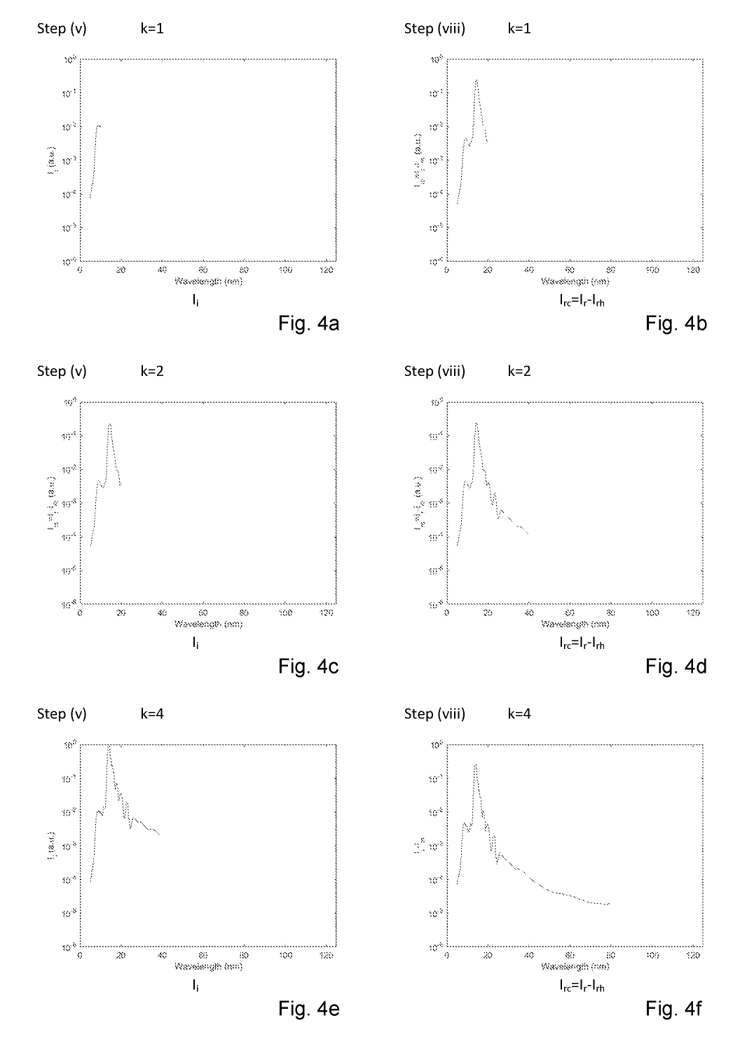

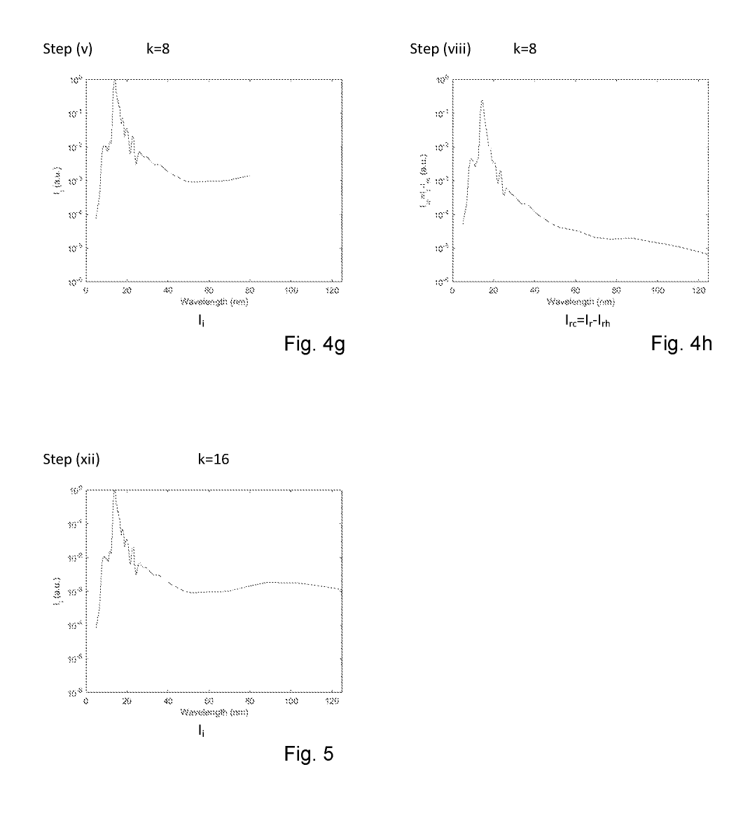

FIG. 4a-FIG. 4h show the spectrum of FIG. 3 after respective intermediate steps of the processing according to the invention,

FIG. 5 shows the spectrum of FIG. 2 as it has been recovered by the processing according to the invention,

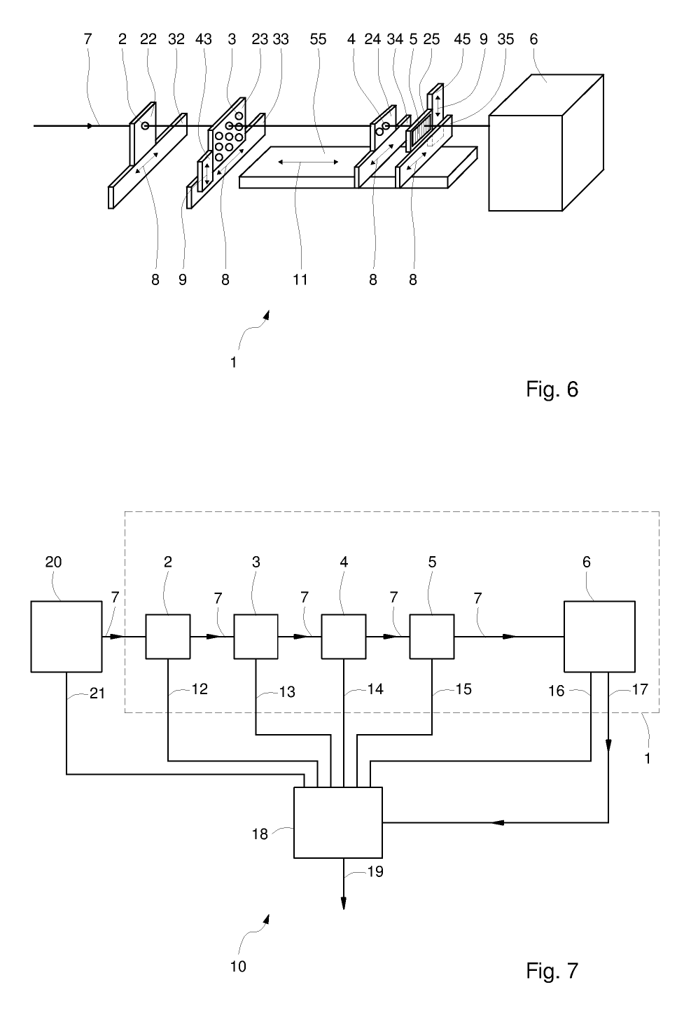

FIG. 6 shows a schematic view of an EUV spectrometer, and

FIG. 7 shows a block diagram of the EUV spectrometer shown in FIG. 6, in combination with an EUV source and a controller according to the invention.

Corresponding components are designated in the figures with the same reference numerals.

FIG. 1 shows a flow chart of an embodiment of the method according to the invention, with steps (i) to (xiii) as can be implemented as a computer program,

FIG. 2 shows a spectrum of a beam of EUV light as emitted by an EUV source, incident to an EUV spectrometer 1 (schematically shown in FIGS. 6-7). This spectrum is the one to be recovered, according to the method of the invention.

FIG. 3 shows the spectrum of in FIG. 2 as recorded by a CCD camera 6 of the EUV spectrometer 1 (schematically shown in FIGS. 6-7). The spectrum shows several higher order contributions, due to the grating 5 in the EUV spectrometer 1, and broadening due to pinhole 4. The spectrum as recorded (represented by line 17 in FIG. 7) by the CCD camera 6 is inputted into a controller, CPU (central processing unit) 18, thus providing the data for the first step (i) START for the processing as illustrated in the flow chart of FIG. 1.

FIG. 4a to FIG. 4h show several intermediate steps (v) and (viii) with parameter k increasing from k=1 to k=8 and λ₀=5 nm, in the processing according to the flow chart of FIG. 1, illustrating the processing of the spectrum as recorded.

FIG. 5 shows the recovered incident spectrum, as obtained after a sufficient amount of iterations.

FIG. 6 shows an EUV spectrometer 1, which comprises a shutter 2 at its entrance, a filter array 3 for selecting specific wavelength bands from the source spectrum, a slit or a pinhole 4, a transmission grating chip 5 for dispersing the light 7 and a detector 6 which is a back-illuminated CCD camera for detection of the spectrum. The shutter 2 is hold in a carrier 22 which is mounted on a motorized translation stage 32 for movement in transverse direction (indicated by arrow 8) with respect to the incoming beam 7. The light 7 from the EUV source is directed to the grating 5 which diffracts each wavelength at a different angle towards the CCD camera 6. Light with a long wavelength is diffracted at larger angles. Consequently the spectral content of the incoming beam 7 can be calculated back from the image recorded by the CCD camera 6. All the components of the spectrometer are contained in a vacuum chamber (not shown). The filter 3 is one selectable out of a set, which set hold in a carrier 23, which is mounted on motorized translation stages 33, 43 for movement in transverse directions (indicated by arrows 8, 9) with respect to the incoming beam 7. The pinhole 4 or slit is hold in a carrier 24 which is mounted on a motorized translation stage 34 for movement in transverse direction 8 and longitudinal direction (indicated by arrow 11) with respect to the incoming beam 7. The transmission grating 5 is one selectable out of a set, which set is hold a carrier 25, which is mounted on motorized translation stages 35, 45 for movement in transverse directions 8, 9 and longitudinal direction 11 with respect to the incoming beam 7. The movements of said translation stages 32, 33, 43, 34, 35, 45, 55 are vacuum compatible motorized, and can be controlled with a computer using a graphical user interface (schematically shown in FIG. 7). The control system allows automated and in situ alignment.

FIG. 7 shows the EUV spectrometer 1 (dashed lines), in combination with an EUV source 20 and a controller 18, which both generates control signals 12, 13, 14, 15, 16 for controlling respectively the shutter 2, the filter array 3, the pinhole 4, the grating 5 and the CCD camera 6, as well as calculates from the output signal 17 of the CCD camera 6 a recovered spectrum according the method of the invention (represented as output signal 19). Moreover, the controller 18 generates control signals 21 for controlling the light source 20 in order to optimize the spectrum of the light emitted by that source.

1. Method for measuring and processing by means of a broadband spectrometer a spectrum of light in a wavelength range from soft x-rays to infrared wavelengths, comprising the steps of:
a) assessing in a measured spectrum a longest wavelength λ0, such that the contribution of higher diffraction orders of wavelengths shorter than the longest wavelength λ0 to the part of the spectrum for wavelengths longer than λ0 is below a previously defined value.

2. The method as claimed in claim 1, wherein the broadband spectrometer includes a shutter, one of a pinhole and a slit, at least one transmission grating and a camera, wherein the processing further comprises the steps of:
(b) removing for wavelengths λ, in the range given by λ0<λ<2λ0 a broadening in the intensity of the light as recorded by the camera, due to the pinhole or slit, and dividing the intensity in the resulting wavelength range by the efficiencies of the grating and the camera, thus obtaining a recovered spectrum in a first spectral range,
(c) calculating contributions of all higher order diffractions in the range given by λ0<λ<2λ0 to the range given by 2λ0<λ<4λ0 and subtracting these contributions from the intensity of the light as recorded by the camera, thus obtaining a recovered spectral range for wavelengths λ in the range given by 2λ0<λ<4λ0, and
(d) repeating the calculation according to steps (b) and (c) for the next adjacent wavelength range, thus obtaining a next adjacent recovered spectral range for wavelengths λ in a next adjacent range, until the complete spectrum as recorded by the camera has been processed and the spectrum from the source has been recovered.

3. The method as claimed in claim 2, wherein the broadband spectrometer further comprises at least one spectral filter, characterized in that the step of removing for wavelengths λ in the range given by λ0<λ<2λ0 a broadening in the intensity of the light as recorded by the camera further comprises dividing the intensity in said wavelength range by the transmission efficiency of the filter.

4. The method as claimed in claim 3, wherein the light source is EUV light, and the step of measuring the spectrum of the EUV light comprises the measuring of an out-of-band spectrum by using a spectral filter which has a low transmission characteristic for radiation with a wavelength about 13.5 nm and a high transmission characteristic for out-of-band wavelengths.

5. The method as claimed in claim 2, wherein the spectral resolution of the spectrometer is maximized by locating the pinhole or slit and the grating within the spectrometer at a maximum distance from the camera.

6. An apparatus for measuring and processing a spectrum of light in a wavelength range from soft x-rays to infrared wavelengths, comprising:
a broadband spectrometer, which spectrometer comprises a shutter, one of a pinhole and a slit, at least one transmission grating and a camera, characterized in that the apparatus is provided with processing means for assessing in a measured spectrum a longest wavelength λ0, such that the contribution of higher diffraction orders of the spectrum for wavelengths shorter than the longest wavelength λ0 to the part of the spectrum for wavelengths longer than λ0 is below a previously defined value.

7. The apparatus as claimed in claim 6, wherein the spectrometer comprises at least one spectral filter.

8. The apparatus as claimed in claim 6, wherein the shutter is held in a carrier which is mounted on a motorized translation stage for movement in a transverse direction with respect to the incoming beam.

9. The apparatus as claimed in claim 7, wherein the at least one spectral filter has a low transmission characteristic for light at an in-band wavelength and a high transmission characteristic for out-of-band wavelengths.

10. The apparatus as claimed in claim 9, wherein the spectrometer is an EUV spectrometer and the in-band represents a bandwidth of 2% around a central wavelength of 13.5 nm.

11. The apparatus as claimed in claim 7, wherein the spectral filter is one selectable out of a set, which set is held in a carrier.

12. The apparatus as claimed in claim 11, wherein the carrier holding the set of spectral filters is mounted on motorized translation stages for movement in transverse directions with respect to the incoming beam.

13. The apparatus as claimed in claim 6, wherein the pinhole or slit is held in a carrier which is mounted on motorized translation stages for movement in transverse and longitudinal directions with respect to the incoming beam.

14. The apparatus as claimed in claim 6, wherein the transmission grating is one selectable out of a set, which set is hold a carrier.

15. The apparatus as claimed in claim 14, wherein the carrier holding the set of transmission gratings is mounted on motorized translation stages for movement in transverse and longitudinal directions with respect to the incoming beam.

16. The apparatus as claimed in claim 14, wherein the set of transmission gratings is provided by a microchip showing an array containing individual transmission gratings.

17. The apparatus as claimed in claim 16, wherein the array is a 3 by 7 matrix in which the individual transmission gratings have line densities of respectively 500, 780, 1000, 1500, 1850, 2000, 2500 lines per mm and starting from 3000 up to 10000 with 1000 lines per mm increments.

18. The apparatus as claimed in claim 6, wherein the pinhole or slit and the grating are arranged at a distal position with respect to the camera.

19. The apparatus as claimed in claim 6, wherein the camera comprises a CCD chip, and the spectrometer includes a blackened plate having an aperture corresponding to the surface dimensions of the CCD chip, placed between the grating and the camera in perpendicular position with respect to the path of the light beam.

20. The apparatus as claimed in claim 6, wherein the control means are adapted for controlling an XUV light source in order to optimize a spectrum of such light source.

21. A non-transitory computer-readable medium that stores a computer program for performing the Computer program for performing a method as claimed in claim 2 when the computer program runs on a computer.
